(19) United States
(12) Patent Application Publication
(10) Pub. No.: US 2005/0083315 A1
(43) Pub. Date: Apr. 21, 2005

(54) Writing instrument with a storage device

(76) Inventor: Yu-Chen Pei, Luchou City (TW)

Correspondence Address: Troxell Law Office PLLC, Suite 1404, 5205 Leesburg Pike, Falls Church, VA, 22041, US

(21) Appl. No.: 10/685,503

(22) Filed: Oct. 16, 2003

(51) Int. Cl. G09G 5/00

(52) U.S. Cl. 345/179

(57) ABSTRACT

A writing instrument with a USB storage includes a cap having a flash memory installed in the cap. A USB plug is formed at a lower end of the cap and electrically connected with the flash memory. A barrel has a chamber defined at an upper end thereof. The USB plug of the cap is inserted in the chamber. A plastic writing tip is formed at a lower end of the barrel. A clip is formed at an outer periphery of the cap. Whereby, the writing instrument can be used for actuating a monitor of a PDA and exchanging data with the PDA or a computer.

### BACKGROUND OF THE INVENTION

1. Field of the Invention

The present invention relates to a writing instrument with a storage device, and more particularly a pen assembled with a Universal Serial Bus (USB) storage and used for a Personal Digital Assistant (PDA).

2. Description of Related Art

With the advantages of small size, light weight and large capability, USB storage devices using flash memories as a storage medium are very well received by consumers. The USB storage has a standard USB plug, which can be connected with a USB port in a computer to exchange data.

In addition, a PDA is generally provided with a plastic pen used for clicking icons and menus and writing on a monitor. The PDA is generally provided with a standard USB port for exchanging data with the USB storage. However, users of PDAs will often lose the plastic pen and thus cannot use the PDA.

Furthermore, although the PDA and the USB storage are small in size, it is still inconvenient for a user to carry the PDA and the USB storage device at the same time.

Therefore, the invention provides a writing instrument with a USB storage device to mitigate or obviate the aforementioned problems.

### SUMMARY OF THE INVENTION

The main objective of the present invention is to provide a writing instrument integrated with a USB storage device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a writing instrument with a USB storage device in accordance with the invention;

FIG. 2 is an exploded perspective view of the writing instrument of FIG. 1; and

FIG. 3 is a partially cross sectional view of the writing instrument.

### DETAILED DESCRIPTION OF THE PREFERRED EMBODIMENT

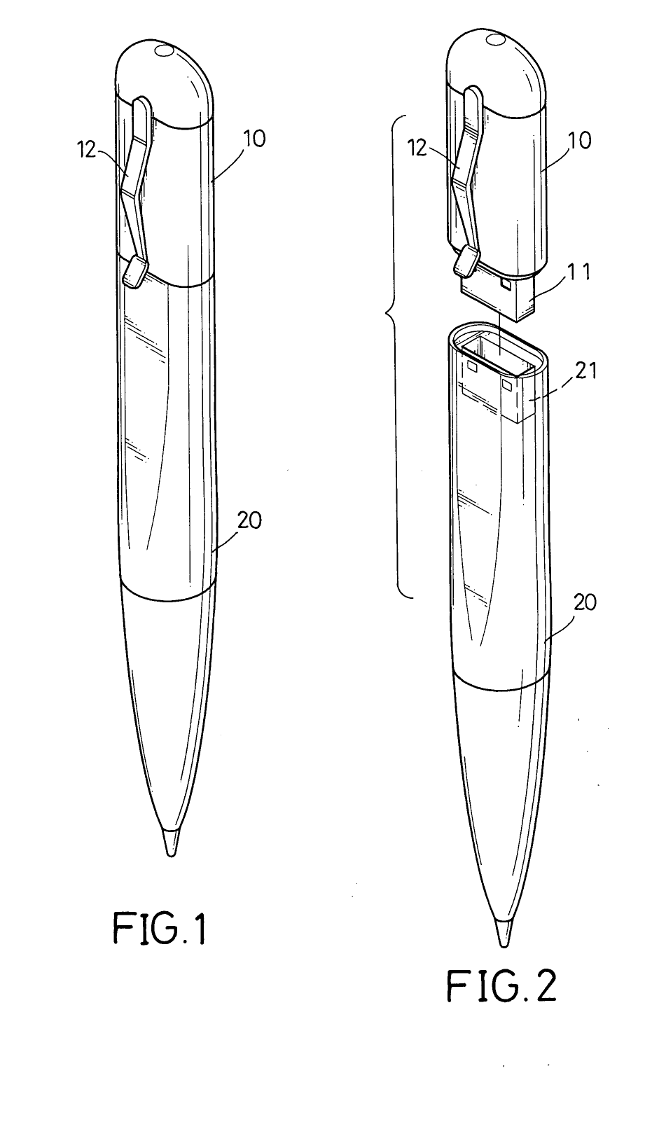

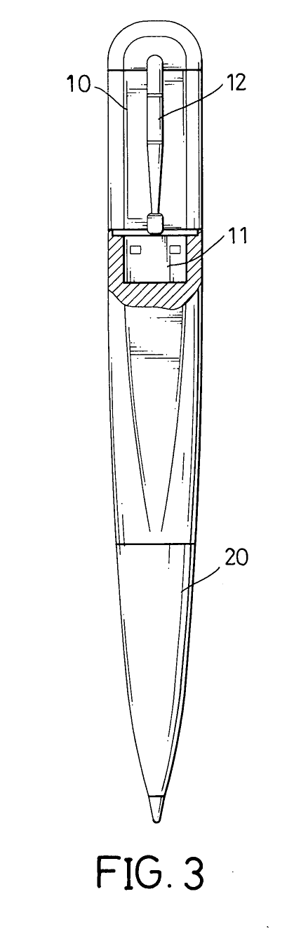

With reference to FIGS. 1-2, a writing instrument in accordance with the invention is composed of a cap (10) and a barrel (20).

The cap (10) has a flash memory and a circuit board (not shown) installed therein and a standard USB plug (11) mounted at a lower end thereof and electrically connected with the flash memory and the circuit board. A clip (12) is provided at an outer periphery of the cap (10).

The barrel (20) has a chamber (21) defined at an upper end thereof, and the USB plug (11) is inserted in the chamber (21). A plastic writing tip (not numbered) is formed at a lower end of the barrel (20).

The barrel (20) also can be formed with an upper part (not numbered) rotatably mounted on a lower part (not numbered). Multiple pens, including a plastic pen and a ballpoint pen (not shown), are received in the barrel (20) and can be selectively extended from the lower end of the barrel (20) by turning the upper part about the lower part. The structure of the rotatable barrel should be known to those skilled in the art and will not be described in detail.

In use, the cap (10) can be removed from the barrel (20) for exchanging data with a PDA or a computer. For actuating icons or writing on a monitor of the PDA, the user can turn the barrel (20) to extend the plastic pen, and for writing on a paper, the user can extend the ballpoint pen. The user can fasten the writing instrument in a pocket or a bag by the clip (10) to prevent the writing instrument from becoming lost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A writing instrument with a USB storage comprising:
a cap having a flash memory installed in the cap and a USB plug formed at a lower end of the cap and electrically connected with the flash memory; and
a barrel having a chamber defined at an upper end of the barrel for receiving the USB plug of the cap, and a plastic writing tip formed at a lower end of the barrel.

2. The writing instrument as claimed in claim 1 wherein the cap has a clip formed at an outer periphery of the cap.
